(19) United States
(12) Patent Application Publication
(10) Pub. No.: US 2018/0260022 A1
(43) Pub. Date: Sep. 13, 2018

(54) METHOD SUITABLE FOR A HEAD MOUNTED DEVICE AND VIRTUAL REALITY SYSTEM

(71) Applicant: HTC Corporation, Taoyuan City (TW)

(72) Inventor: Sheng-Yang PAN, TAOYUAN CITY (TW)

(21) Appl. No.: 15/451,421

(22) Filed: Mar. 7, 2017

(51) Int. Cl. G06F 3/01; G06T 3/60

(52) U.S. Cl. CPC G06F 3/012; G06T 2200/24; G06T 3/60

(57) ABSTRACT

A method suitable for a head mounted device. The method includes: sensing a rotational data of the head mounted device; generating a tangling prediction according to a continuous degree of the rotational data; determining a cable tangling parameter according to the tangling prediction; determining that whether a cable is going to tangle according to the cable tangling parameter; and adjusting a virtual reality content when the cable is going to tangle.

### BACKGROUND

### Field of Invention

The present invention relates to a method suitable for a head mounted device and virtual reality system. More particularly, the present invention relates to a method suitable for a head mounted device and virtual reality system by adjusting the virtual reality content to prevent a cable from tangling.

### Description of Related Art

In a game or an interactive content of a virtual reality system, the cables are easily tangling when the player (or user) walks or moves. The cables uses for transmitting signals between the controller (e.g., hand controller devices or head mounted device) and the host. The tangled cables may make player fall down or tie up the body. Thus, the tangled cables may cause dangerous issue or inconvenient issue when the player operates the virtual system.

Besides, the cables also limit the interactive region of a lot of games. For example, some interactive games are limited to interactive with the player only in the 180-degree front-side corresponding to the center of virtual reality content, so as to avoid the cable tangling issue. However, the traditional solutions limit the interactive regions. It may impact the interestingness of the game content. As such, the solution cannot provide a better user experience for the player.

Therefore, how to provide a method for preventing a cable from tangling in a virtual reality system and providing the better user experience in the same time becomes a problem to be solved.

### SUMMARY

One aspect of the present disclosure is related to a method suitable for a head mounted device. The method includes: sensing a rotational data of the head mounted device; generating a tangling prediction according to a continuous degree of the rotational data; determining a cable tangling parameter according to the tangling prediction; determining that whether a cable is going to tangle according to the cable tangling parameter; and adjusting a virtual reality content when the cable is going to tangle. Another aspect of the present disclosure is related to a virtual reality system. In accordance with one embodiment of the present disclosure, the virtual reality system includes: a head mounted device and a control device. The head mounted device is configured to sense a rotational data and transmit the rotational data by a cable. And, the host device is configured to receive the rotational data by the cable and generate a tangling prediction according to a continuous degree of the rotational data, determine a cable tangling parameter according to the tangling prediction, determine that whether the cable is going to tangle according to the cable tangling parameter, and adjust a virtual reality content when the cable is going to tangle.

Through the method suitable for a head mounted device and virtual reality system described above, the user will not be interrupted by the tangled cable issue while interacting with the virtual reality content. The virtual reality system can dynamically adjust the virtual reality content when the cable is tangled according to the cable tangling parameter. It helps the user move to the appropriate direction, so as to avoid the user tangling by or stumbling over the cable. Therefore, the method for preventing the cable from tangling and the virtual reality system also provides a better user experience.

### BRIEF DESCRIPTION OF THE DRAWINGS

FIGS. 1A-1B are schematic diagrams of a virtual reality system according to one embodiment of the present invention.

FIGS. 2A-2D are schematic diagrams of a method for preventing a cable from tangling according to one embodiment of the present invention.

FIG. 3 is a flowchart of a method for preventing a cable from tangling according to one embodiment of the present invention.

### DETAILED DESCRIPTION

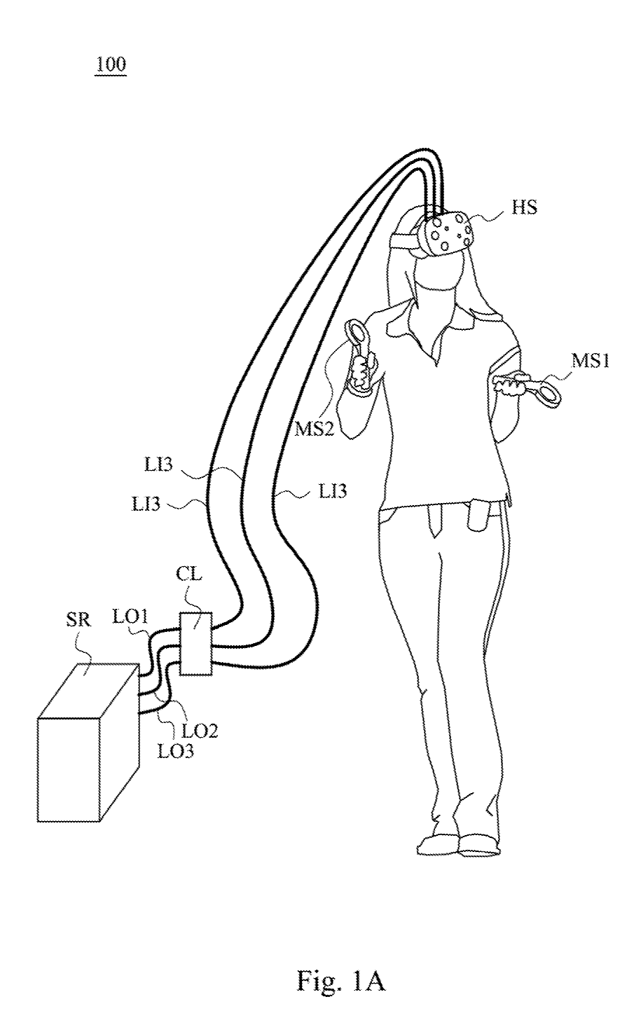

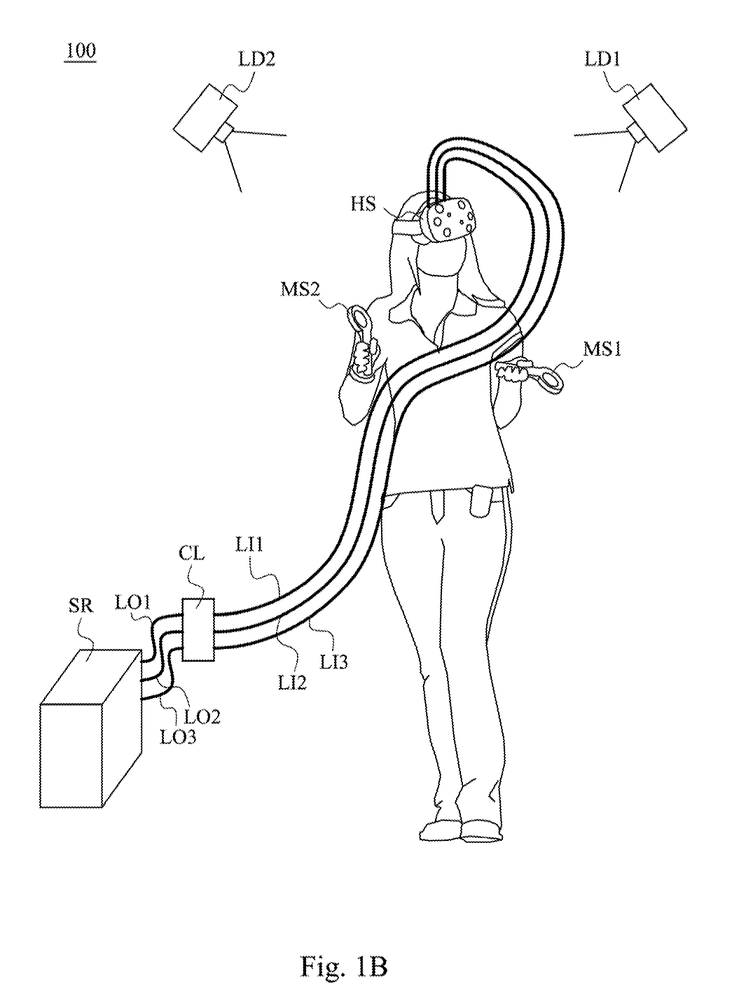

Reference is made to FIG. 1A, FIG. 1A is a schematic diagram of a virtual reality system 100 according to one embodiment of the present invention. As shown in FIG. 1A, the virtual reality system 100 includes: a head mounted device HS and a host device SR. In one embodiment, the virtual reality system 100 further includes at least one motion-sensitive device (e.g., motion-sensitive device MS1, MS2).

In one embodiment, the head mounted device HS is operative for providing immersive virtual reality for the wearer (or the player). In one embodiment, the player wears the head mounted device HS on his/her head to see the virtual reality content. The head mounted device HS is widely used with computer games and also used in some applications, such as simulators and trainers. In some embodiment, the head mounted device HS includes a stereoscopic head-mounted display to provide separate images for each eye, a stereo sound component and/or head motion tracking sensors. In some embodiment, the head motion tracking sensors include gravity-sensor(s), accelerometer(s) and/or structured light system(s), etc. In some embodiment, the head mounted device HS also has eye-tracking sensors and gaming controllers.

In one embodiment, the control device CL is connected to the head mounted device HS by at least one cable (e.g., cables LI1, LI2 and/or LI3). In one embodiment, the cable LI1 can be realized by a HDMI (High-Definition Multimedia Interface) cable for transmitting the information related to the multimedia. In one embodiment, the cable LI2 can be realized by a USB cable for transmitting the signal and/or data between the control device CL and head mounted device HS. In one embodiment, the cable LI3 can be realized by a power cable.

In one embodiment, the formats of the information (or the signal) separately transmitted from the head mounted device HS and the host device SR may be different, and the control device CL can be realized by a communication bridge for transforming and/or transmitting the information or signal between the head mounted device HS and the host device SR.

On the other hand, the control device CL is connected to the host device SR by at least one cable (e.g., cables LO1, LO2 and/or LO3). In one embodiment, the cable LO1 can be realized by a HDMI (High-Definition Multimedia Interface) cable for transmitting the information related to the multimedia. In one embodiment, the cable LO2 can be a USB cable for transmitting the signal and/or data between the control device CL and head mounted device HS. In one embodiment, the cable LO3 can be can be a power cable.

In one embodiment, the host device SR can be implemented by a computer, a server and/or other device having calculation function. The host device SR is operative for storing the virtual reality content (e.g. game data), calculating the player's movement or position, and generating the virtual reality images corresponding to the player's movement or position.

In one embodiment, the head mounted device directly connects to the host device SR by one or more cable. In one embodiment, the head mounted device HS can directly connect to the host device SR by at least one cable, without using the control device CL. In one embodiment, the host device SR translates the received information to the readable format of itself.

In one embodiment, player (or user) holds the motion-sensitive devices MS1, MS2. And, the motion-sensitive devices MS1, MS2 enable the player to interact with the virtual reality content (e.g., the digital landscape). In one embodiment, the motion-sensitive devices MS1, MS2 transmits the motion information or signal to the host device SR by wire or wireless connection.

Reference is made to FIG. 1B, FIG. 1B is a schematic diagram of a virtual reality system 100 according to one embodiment of the present invention. As shown in FIG. 1B, the cables LI1-LI3 tangle the player's body when the current rotation angle of the player exceeds a tangling threshold (e.g., 360-degree or 720-degree). In one embodiment, the current rotation angle is detected in accordance with the rotation of the player's head while the user wears the head mounted device HS. For example, when the user swings of the body, walking around or turning around to different directions or other body motions. For avoiding this situation, the invention provides a method for preventing a cable from tangling. The method is described as following content.

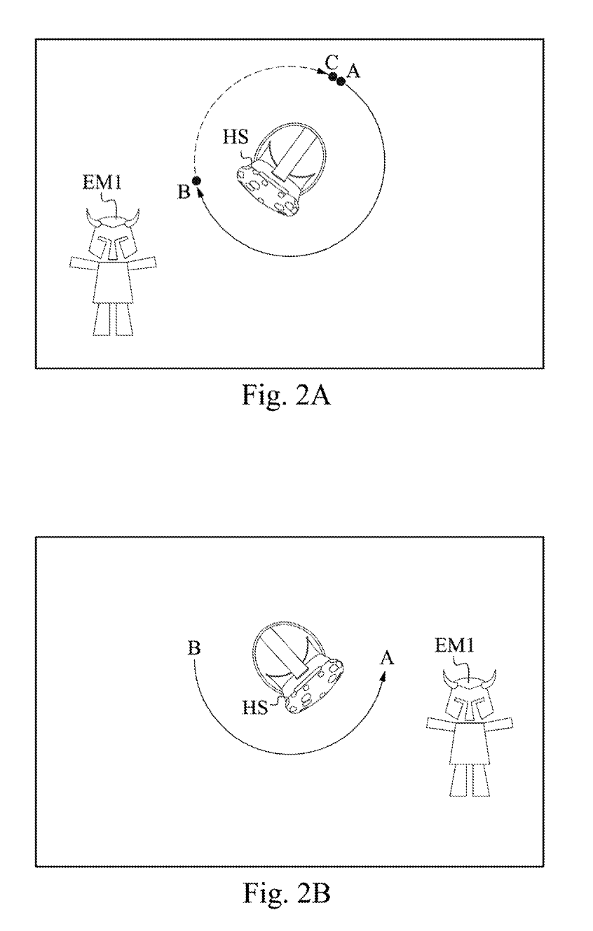

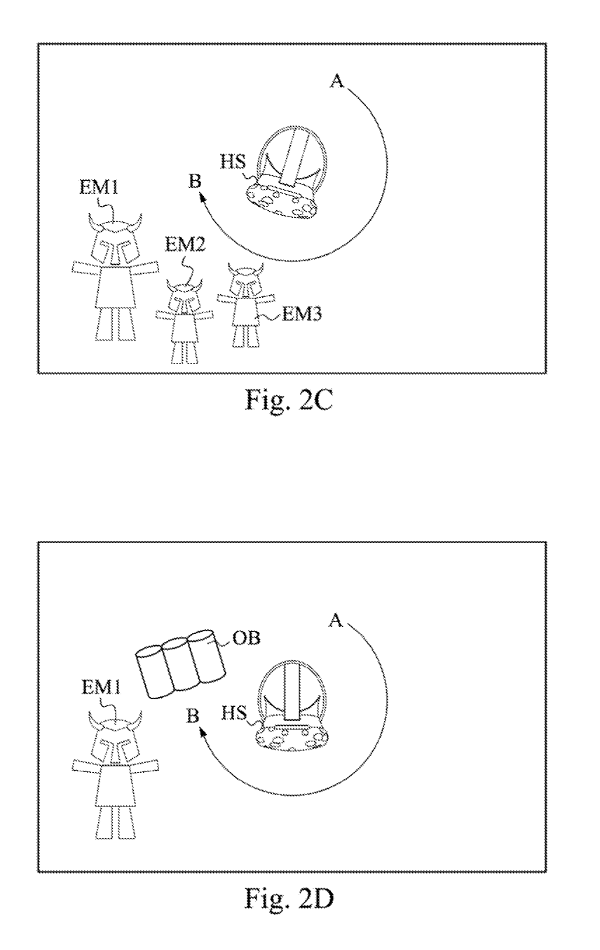

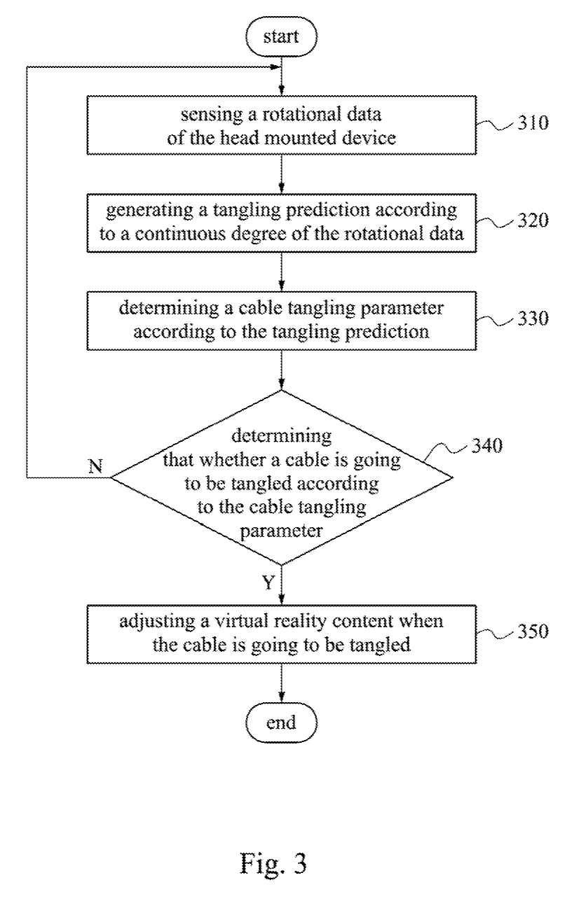

Reference is made to FIGS. 2A-2D and 3, FIGS. 2A-2D are schematic diagrams of a method for preventing a cable from tangling according to one embodiment of the present invention. FIG. 3 is a flowchart of a method for preventing a cable from tangling according to one embodiment of the present invention. In one embodiment, the head mounted device HS is configured to couple to a first terminal of at least one first cable (for example, the first cable can be cable(s) LI1, LI2 and/or LI3). And, the control device CL is configured to couple to a second terminal of the at least one first cable. In addition, the host device SR is coupled to the control device CL by at least one second cable (e.g., cable(s) LO1, LO2 and/or LO3).

In step 310, the head mounted device HS senses a rotational data and transmits the rotational data by a cable (e.g., at least one of the cable LI1, LI2, LI3, LO1, LO2 and LO3).

In one embodiment, as shown in FIG. 1B, the virtual reality system 100 further includes at least one lighthouse (e.g., lighthouses LD1 and/or LD2). In one embodiment, the lighthouses LD1 and LD2 can be implemented by the laser devices.

In one embodiment, the at least one lighthouse (e.g., lighthouse LD1 and/or LD2) keeps projecting the laser according to a fixed frequency. When the laser hits or touches the head mounted device HS, at least one sensor (e.g. one or more light sensor) on the head mounted device HS detects the laser. And then, the head mounted device HS transmits the data related to which sensor(s) is/are hit by the laser or the time point(s) of sensor(s) is/are hit by the laser to the host device SR. The data herein is defined as rotational data. In one embodiment, the rotational data represents the rotation degree, the position and/or the rotation direction of the head mounted device HS. Thus, in the following steps, the host device SR calculates the rotation, or the position of the head mounted device HS according to the rotational data.

It should be noticed that the cable can be implemented by at least one of the cable LI1, LI2, LI3, LO1, LO2 and LO3 in some embodiment. In other words, the person skilled in the art can easily understand that the cable in present invention can be implemented (or interpreted) as, e.g., cables LI1, cables LI1 and LI2, cables LO1, LI3 and LI3 . . . , or other combination.

In step 320, the host device SR generates a tangling prediction according to a continuous degree of the rotational data.

In one embodiment, the host device SR calculates (or predict) the rotation or the position of the head mounted device HS according to the rotational data. When the rotational data represents the head mounted device HS continuously rotates to the same direction (e.g., the head mounted device HS keeps rotating clockwisely), the host device SR generates the tangling prediction according to the continuous degree of the rotational data. And, the tangling prediction represents the predicted rotation direction of the head mounted device HS (e.g., the tangling prediction represents that the head mounted device HS will continuously turn in clockwise).

In step 330, the host device SR determines a cable tangling parameter according to the tangling prediction.

In one embodiment, the host device SR further determines a current rotation angle of the cable according to the cable tangling parameter.

For example, when the tangling prediction represents that head mounted device HS is going to clockwisely rotate into the second turn, the host device SR determines the cable tangling parameter as 2. For another example, when the tangling prediction represents that head mounted device HS is going to clockwisely rotate into the third turn, the host device SR determines the cable tangling parameter as 3.

In one embodiment, the host device SR determines a current rotation angle of the cable according to the cable tangling parameter.

In some embodiment, the host device SR analyzes the current rotation angle also represents a clockwise angle or a counterclockwise angle according to the tangling prediction.

For example, when the cable tangling parameter is two, the current rotation angle of the cable is determined as 720-degree in clockwise. For another example, when the cable tangling parameter is 3, the current rotation angle of the cable is determined as 1080-degree in counterclockwise.

In one embodiment, the current rotation angle is proportional to the cable tangling parameter. For example, the current rotation angle is 360-degree in clockwise when the cable tangling parameter is 1. For another example, the current rotation angle is 540-degree when cable tangling parameter is 1.5.

In one embodiment, the current rotation angle also can be obtained according to the room setup information. The room setup information comprises an operation space data. The operation space data, which is set by the user, is configured for setting up a virtual reality operation space. And, the host device SR analyzes the data received from the head mounted device HS to obtain a location information. By the location information, the room setup information and/or the current rotation angle of the cables, the host device SR precisely calculates the cable tangling parameter.

In one embodiment, the host device SR analyzes the rotational data (which may comprise the information of the rotation degree, the position and/or the rotation direction of the head mounted device HS) received from the head mounted device HS, so as to obtain the cable tangling parameter.

In another embodiment, the host device SR predicts the cable tangling parameter according to the rotational data detected by the head mounted device HS.

In one embodiment, the head mounted device HS includes a gravity-sensor and/or a light sensor. The gravity-sensor and/or a light sensor senses a head direction or a head rotation during an operation period, for example, the gravity-sensor and/or a light sensor detects the head direction or head rotation of each time point (e.g., every 10 microseconds detects once) for sensing the rotational data, so as to calculate the continuous degree of the rotational data for generating the cable tangling parameter.

As such, the host device SR further calculates the cable tangling parameter according to the head direction or head rotation detected by the gravity-sensor and/or a light sensor of the head mounted device HS.

In one embodiment, the current rotation angle is defined according to a rotated degree or a rotated variation or corresponding to the initial position of the head mounted device HS.

In step 340, the host device SR determines that whether a cable (e.g., at least one of the cable LI1, LI2, LI3, LO1, LO2 and LO3) is going to tangle according to the cable tangling parameter.

In one embodiment, the host device SR determines that whether the at least one first cable or the at least one second is going to tangle according to the cable tangling parameter. If the host device SR determines that the at least one first cable or the at least one second is going to tangle according to the cable tangling parameter, the step 350 is performed. If the host device SR determines that the at least one first cable or the at least one second is not going to tangle according to the cable tangling parameter, the procedure goes back to step 310.

In one embodiment, the host device SR determines that the cable is going to tangle when the cable tangling parameter is higher than a tangling threshold.

For example, the host device SR determines that the first cable is going to tangle when the cable tangling parameter of the first cable (e.g., cable LI1) is 2 and is the tangling threshold is predetermined as 1.5.

For example, the host device SR determines that the first cable is going to tangle when the cable tangling parameter of the first cable (e.g., cables LI1) and second cable (e.g., cables LI2) is 1.75 and the tangling threshold is predetermined as 1.5.

For another example, the host device SR determines that the first cable is not going to tangle when the cable tangling parameter of the first cable (e.g., cable LI1) is 0.5 and the tangling threshold is predetermined as 1.5.

In some embodiment, the host device SR predicts that whether the at least one first cable or the at least one second will tangle by recording and analyzing the rotational data of the head mounted device HS.

In some embodiment, the host device SR predicts that whether the at least one first cable or the at least one second will tangle according to the prediction algorithm or the total the movement variance of the head mounted device HS. The prediction algorithm can be realized by an existed algorithm. Therefore, it is no more described herein.

In step 350, the host device SR adjusts a virtual reality content when the cable (e.g., at least one of the cable LI1, LI2, LI3, LO1, LO2 and LO3) is going to tangle.

In one embodiment, the host device SR adjusts a virtual reality content when the at least one first cable or the at least one second cable is going to tangle. FIGS. 2A-2D represents the virtual reality content seen by the player when the player wears the head mounted device HS. In one embodiment, virtual reality content is provided by the host device SR through the cables (e.g. cables LI1 and LO1) and the control device CL. The virtual reality content of FIGS. 2A-2D are shown by the stereoscopic head-mounted d splay in the head mounted device HS.

In one embodiment, as shown in FIG. 2A, the player's head moves from point A to point B along the arrows for trancing an interest point EM1 (e.g., the virtual enemy). The current rotation angle is generated by rotating the head mounted device HS from point A to point B. And the host device SR determines (or predicts) that the at least one first cable or the at least one second cable is going to tangle if the head mounted device HS keeps rotating from point B to point C. Therefore, the following embodiments provide the method for prevents the cable from tangling. However, the invention is not limited by the examples as FIGS. 2A-2D.

In one embodiment, the host device SR dynamically adjusts the virtual reality content according to a current rotation angle and provides a user interface or a virtual reality image by the stereoscopic head-mounted display in the head mounted device HS after adjusting the virtual reality content.

In one embodiment, an interest point EM1 (e.g., the virtual enemy followed by the player) in the virtual reality content is moved to an opposite direction (e.g. from point B to point A shown in FIG. 2B) relative to the current rotation angle (e.g. from point A to point B shown in FIG. 2A) when the first cable or the second cable is going to tangle. For example, as shown in FIG. 2B, the interest point EM1 moves from point B to point A. As such, the player will be attracted by the interest point EM1 to move from point B to point A along the arrows. Also, it avoids the player's head keeps rotating from an arc direction from the point B to point C. In his way, the at least one first cable or the at least one second cable rotates in the opposite direction relative to the current rotation angle. Therefore, it prevents the at least one first cable or the at least one second cable from tangling.

In one embodiment, the interest point EM1 in the virtual reality content is moved clockwisely when the current rotation angle represents a counterclockwise angle.

In one embodiment, the interest point EM1 in the virtual reality content is moved counterclockwisely when the current rotation angle represents a clockwise angle.

In one embodiment as shown in FIG. 2C, at least one new object (e.g., new object EM2, EM3) of the virtual reality content is generated in an opposite direction relative to the current rotation angle when the at least one first cable or the at least one second cable is going to tangle. As such, the gaze of the player will focus on the new objects EM2, EM3 (e.g., the new object EM2, EM3 can be implemented as new virtual enemies) to move from point B to point A along the arrows for tracing the new objects EM2, EM3. In this way, the at least one first cable or the at east one second cable may rotate In the opposite direction (e.g. from point B to point A shown in FIG. 2C) relative to the current rotation angle (e.g. from point A to point B shown in FIG. 2A). Furthermore, the new objects EM2, EM3 are not limited to on the horizontal line. For example, the user's view of new object EM2 is higher than the user's view of the interest point EM1, and the user's view of new object EM3 is lower than the user's view of the interest point EM1. Therefore, it prevents the at least one first cable or the at least one second cable from tangling.

In one embodiment, as shown in FIG. 2D, an obstacle object OB of the virtual reality content is generated according to the current rotation angle when the at least one first cable or the at least one second cable is going to tangle. In this way, the player's head will stop rotating from point A to point B along the arrows of the arc direction because the obstacle object OB is blocked the user's view. Therefore, it prevents the at least one first cable or the at least one second cable from keeping tangling.

Based on above embodiments, by adjusting the artificial intelligence and/or the procedure of the game (or the content) can help to prevent the at least one first cable or the at least one second cable from tangling.

Through the method suitable for a head mounted device and virtual reality system described above, the user will not be interrupted by the tangled cable issue while interacting with the virtual reality content. The virtual reality system can dynamically adjust the virtual reality content when the cable is going to tangle according to the cable tangling parameter. It helps the user move to the appropriate direction, so as to avoid the user tangling by or stumbling over the cable. Therefore, the method for preventing the cable from tangling and the virtual reality system also provides a better user experience.

Although the present invention has been described in considerable detail with reference to certain embodiments thereof, other embodiments are possible. Therefore, the scope of the appended claims should not be limited to the description of the embodiments contained herein.

1. A method, suitable for a head mounted device, comprising:
sensing a rotational data of the head mounted device;
generating a tangling prediction according to a continuous degree of the rotational data;
determining a cable tangling parameter according to the tangling prediction;
determining a current rotation angle of the cable according to the cable tangling parameter, wherein the current rotation angle of the cable is along a first direction in which the head mounted device rotates;
determining that whether a cable is going to tangle according to the cable tangling parameter, wherein the cable is going to tangle when the cable tangling parameter is higher than a tangling threshold; and
when the cable to tangle, moving an interest point in the virtual reality content to an opposite direction of the first direction to attract an user to rotate the cable in the opposite direction.

2. (canceled)

3. (canceled)

4. (canceled)

5. (canceled)

6. The method of claim 1, wherein the interest point in the virtual reality content is moved clockwisely when the current rotation angle represents a counterclockwise angle.

7. The method of claim 1, wherein the interest point in the virtual reality content is moved counterclockwisely when the current rotation angle represents a clockwise angle.

8. The method of claim 1, further comprising:
dynamically adjusting the virtual reality content according to current rotation angle; and
providing a user interface or a virtual reality image after adjusting the virtual reality content.

9. The method of claim 1, cable tangling parameter further comprising:
sensing the rotational data by a gravity-sensor or a light sensor of the head mounted device during an operation period, so as to calculate the continuous degree of the rotational data for generating the cable tangling parameter.

10. The method of claim 1, wherein the cable is coupled to the head mounted device and a control device.

11. A virtual reality system, comprising:
a head mounted device configured to sense a rotational data and transmit the rotational data by a cable; and
a host device configured to receive the rotational data by the cable and generate a tangling prediction according to a continuous degree of the rotational data, determine a cable tangling parameter according to the tangling prediction, determine a current rotation angle of the cable according to the cable tangling parameter, determine that whether the cable is going to tangle according to the cable tangling parameter, wherein the current rotation angle of the cable is along a first direction in which the head mounted device rotates;
wherein the host device determines that the cable is going to tangle when the cable tangling parameter is higher than a tangling threshold, and
when the cable is going to tangle, an interest point in the virtual reality content is moved to an opposite direction of the first direction to attract an user to rotate the cable in the opposite direction.

12. (canceled)

13. (canceled)

14. (canceled)

15. (canceled)

16. The virtual reality system of claim 11, wherein the interest point in the virtual reality content is moved clockwisely when the current rotation angle represents a counterclockwise angle.

17. The virtual reality system of claim 11, wherein the interest point in the virtual reality content is moved counterclockwisely when the current rotation angle represents a clockwise angle.

18. The virtual reality system of claim 11, wherein the host device dynamically adjusts the virtual reality content according to current rotation angle and provides a user interface or a virtual reality image after adjusting the virtual reality content.

19. The virtual reality system of claim 11, further comprising:
a gravity-sensor configured in the head mounted device;
a light sensor configured in the head mounted device;
wherein the gravity-sensor or the light sensor senses a the rotational data during an operation period, so as to calculate the continuous degree of the rotational data for generating the tangling prediction.

20. The virtual reality system of claim 11, wherein the cable is coupled to the head mounted device and a control device.

21. A method, suitable for a head mounted device, comprising:
sensing a rotational data of the head mounted device;
generating a tangling prediction according to a continuous degree of the rotational data;
determining a cable tangling parameter according to the tangling prediction;
determining a current rotation angle of the cable according to the cable tangling parameter, wherein the current rotation angle of the cable is along a first direction in which the head mounted device rotates;
determining that whether a cable is going to tangle according to the cable tangling parameter, wherein the cable is going to tangle when the cable tangling parameter is higher than a tangling threshold; and
when the cable is going to tangle, generating an interested point in the virtual reality content in an opposite direction of the first direction to attract an user to rotate the cable in the opposite direction.
